(19) United States
(12) Patent Application Publication
(10) Pub. No.: US 2021/0215572 A1
(43) Pub. Date: Jul. 15, 2021

(54) Inspection Tip Having a Self-Adjusting Prism for an Optical Fiber and Method of Use

(71) Applicants: Ky LY, Shenzhen (CN); Edward Albert TRANTER, Maidenhead (GB)

(72) Inventors: Ky LY, Shenzhen (CN); Edward Albert TRANTER, Maidenhead (GB)

(73) Assignee: Senko Advanced Components, Inc., Marlborough, MA (US)

(21) Appl. No.: 17/187,644

(22) Filed: Feb. 26, 2021

Related U.S. Application Data
(63) Continuation of application No. PCT/US19/49780, filed on Sep. 5, 2019.
(60) Provisional application No. 62/727,034, filed on Sep. 5, 2018.

(51) Int. Cl. G01M 11/00; G02B 6/34; G02B 6/38

(52) U.S. Cl. CPC G01M 11/31; G02B 6/385; G02B 6/34

(57) ABSTRACT

A ferrule endface inspection tool with a straight tip is provided. The tool deploys a wedged prism at the inspection end or the end of the tool nearer the ferrule endface. The prism endface is cut at an offset angle of about eight degrees and thus allows light exiting the prism to enter the ferrule end face with an opposing APC ferrule tip. Since the entry is at zero degrees into the opposing APC ferrule endface then under Snell's Law there is no theoretical signal loss, and the returned or reflected light signal is imaged at no loss.

### RELATED APPLICATION

This application is a continuation of PCT/US19/49780 filed on Sep. 5, 2019, now published as WO/2020/051353 titled “Inspection Tip Having a Self-adjusting Prism for an Optical Fiber and Method of Use”, which claims priority to U.S. provisional patent application 62/727,034 filed Sep. 5, 2018, titled “Inspection Tip having a Self-Adjusting Prism and a Method of Operating”.

### FIELD OF THE INVENTION

The present invention relates to optical fiber connectors, and more particularly, to inspecting an optical fiber formed as part of a ceramic or plastic ferrule.

### BACKGROUND

The prevalence of the Internet has led to unprecedented growth in communication networks. Consumer demand for service and increased competition has caused network providers to continuously find ways to improve quality of service while reducing cost.

In inspecting an optical fiber tip, an endface inspection tool delivers light into ferrule with an optical fiber therein. An image sensor processes the reflected light and returns a picture of the endface to a user. A clean ferrule and optical fiber should look like FIG. 13. FIG. 10 depicts an endface that is dirty or damaged. An obscured endface interferes with the light exiting the optical fiber at the endface of the ferrule. This distortion results poor signal quality. Simply put, the blocking of light or bending of light results in data loss that is contained in the light signal. In operation, the light signal exiting the ferrule endface or optical fiber therein carries data that is interpreted using a receiver device.

A ferrule endface at an angle is called a APC ferrule tip or angled physical contact. Industry standard has the ferrule tip angle at about eight (8) degrees to the normal of the ferrule endface as depicted in FIG. 16. An endface offset cut may be from six (6) degrees to ten (10) degrees due to manufacturing error. A common operation is to inspect optical connectors already inserted in an adapter or bulkhead adapter, as depicted in FIG. 11. Not only does an adjacent fiber optic connector interfere with the inspection tool, the prior art inspection tool tip is at an angle.

In communication networks, such as data centers and switching networks, numerous interconnections between mating connectors may be arranged in high-density panels. Panel and connector producers are optimized for such high densities by shrinking the connector size and/or the spacing between adjacent connectors secured in the panel. While both approaches may be effective to increase the panel connector density, shrinking the connector size and/or spacing may also increase the support cost, diminishes the quality service and access to the connectors stored. on the opposing side of a bulkhead adapter and not accessible by the user.

In a high-density panel configuration, adjacent connectors and cable assemblies may obstruct access to adapter ports that have opposing connectors that need to be inspected. These obstructions impede the ability of an operator to use an inspection tool to measure debris or damage to an optical fiber at the endface of a ferrule. Since the connectors are part of a dense group of connectors behind panel, the cost of an improper inspection is disassembling the panel, which shuts down a portion of the data network among other losses. While an operator may attempt to use a tool, such as a screwdriver, to reach into a dense group of connectors and activate a release mechanism, the time to release and replace the connector is lost when the inspection is faulty.

### BRIEF DESCRIPTION OF THE DRAWINGS

FIG. 1 is a perspective view of a prior art inspection tool;

FIG. 2 is a perspective view of the present invention;

FIG. 3 is an exploded view of FIG. 2;

FIG. 4 is an exploded view of the Probe tip assembly for FIG. 2;

FIG. 5 is a perspective view of the probe tip assembly without the wedged prism installed;

FIG. 6A is a perspective view of a flexible sealant substantially about the edged prism;

FIG. 6B is a cross-section view of the probe tip of the present invention;

FIG. 7 is a side view of a prism holder according to the present invention;

FIG. 8 is a backside view of the prism holder of FIG. 7;

FIG. 9 is a perspective view of the prism holder with an edged shape prism;

FIG. 10 is an image view of the prior art inspection tool viewing a first ferrule endface;

FIG. 11 is a view of the prior art inspection tool inserted into a bulkhead adapter adjacent a fiber optic connector with a short boot;

FIG. 12 is a view of the prior art inspection, tool inserted into a bulkhead adapter adjacent a fiber optic connector with a long boot;

FIG. 13 is an image view of the same ferrule endface as in FIG. 10, but imaged using the present invention;

FIG. 14 is a view of the present invention inspection tool inserted into a bulkhead adapter adjacent a fiber optic connector with a short boot;

FIG. 15 is a view of the present invention inspection tool inserted into a bulkhead adapter adjacent a fiber optic connector with a long boot, and

FIG. 16 is a view of an angled physical contact ferrule endface and an ultra physical contact ferrule endface.

### DETAILED DESCRIPTION

A connector, as used herein, refers to a device and/or components thereof that connects a first module or cable to a second module or cable. The connector may be configured for fiber optic transmission or electrical signal transmission.

An adapter, as used herein, refers to a device with a housing with one or more ports. Each port can receive and secure with a fiber optic connector. A port may have an opposing port connected by a channel allowing opposing fiber optic connectors to communicate. A transceiver has a port on a first side and a light source in a second opposing port.

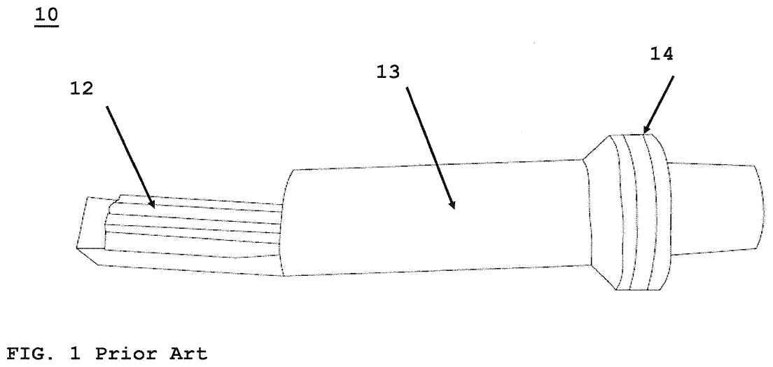

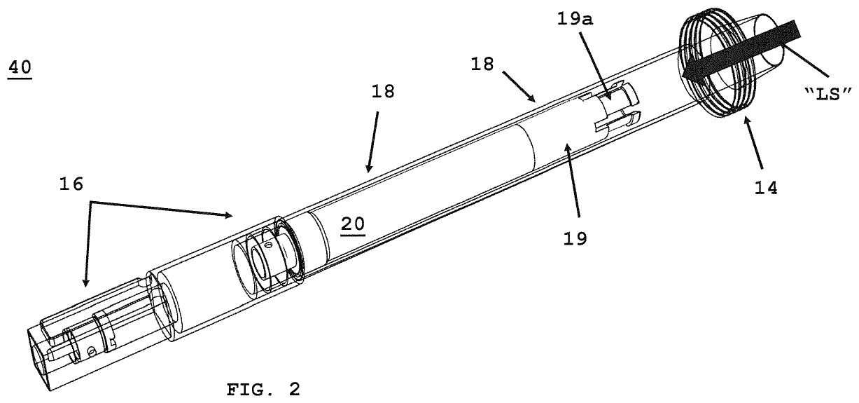

FIG. 1 depicts a prior art inspection probe assembly 10 with short body 13 and angled probe tip 12, and threaded end with taper 14 to accept a measurement device (not shown) that delivers a light source “LS” and images the reflected light off a ferrule enface. FIG. 2 depicts the present invention straight tip long body fiber inspection probe 40 with probe tip assembly 16 configured to accept extended body 18. Extended body 18 covers or contains inner housing 20 with latch assembly 19 at a distal end of inner housing 20. Latch assembly 19 has one or more latch 19a. Latch 19a aids in accepting and securing the measurement device. The measure device provides a light source “LS”, and the measurement device is also threaded onto threaded end with taper 14, as in prior art device 10.

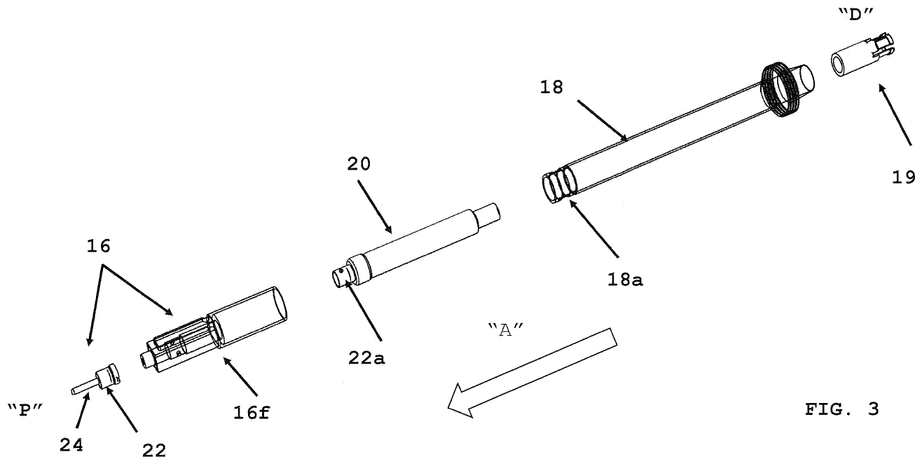

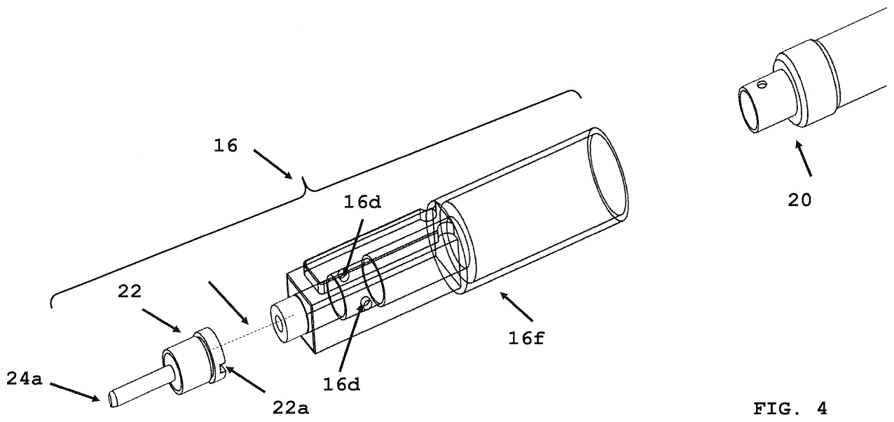

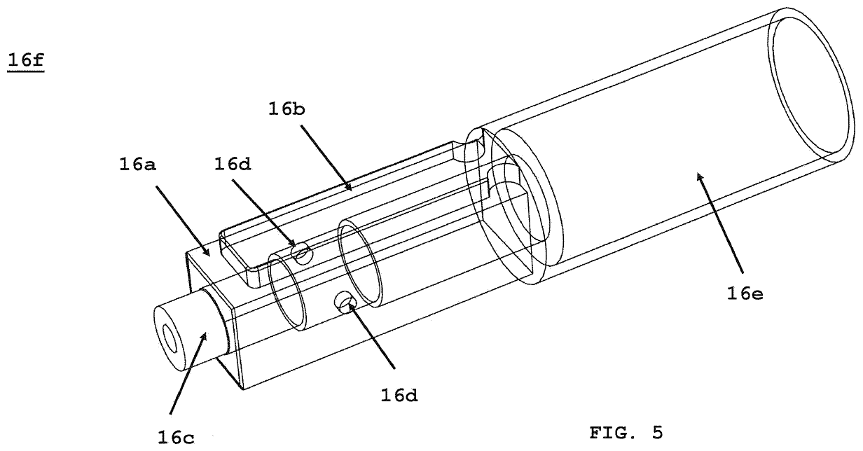

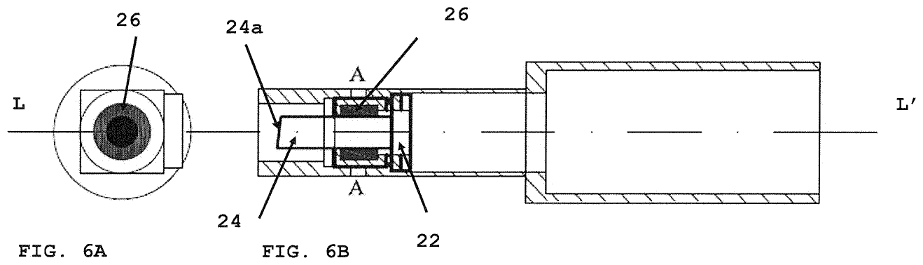

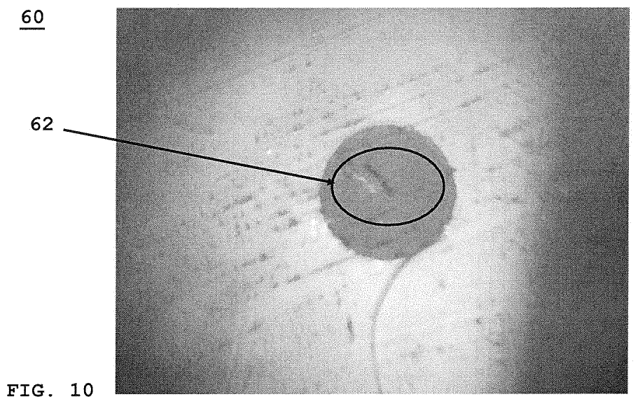

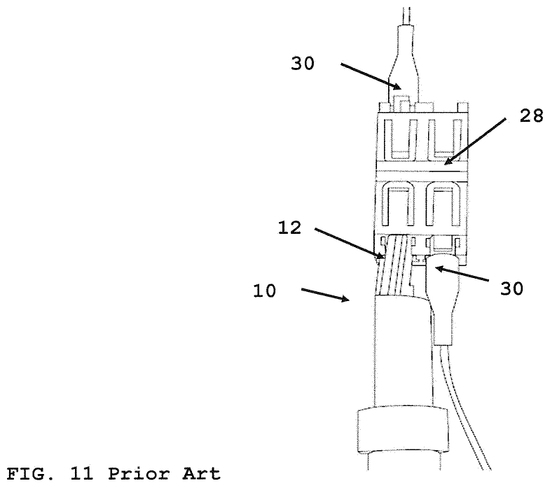

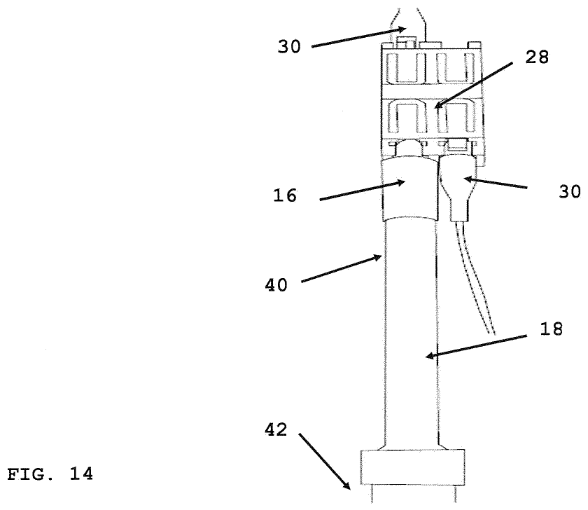

FIG. 3 depicts an exploded view of the present invention. Fiber inspection probe tip assembly 16 is formed as plug frame assembly 16f having plug frame housing 16a with alignment key 16b (refer to FIG. 4 and FIG. 5). Alignment key 16b ensures straight tip long body fiber inspection probe tip 40 is aligned and oriented within an adapter port, as depicted in FIG. 14. Stub 16c (FIG. 5) accepts a distal end of prism holder 22. Prism holder 22 has secured therein by flexible sealant 26 (refer to FIG. 6A) wedged prism 24, at proximal end “P” of the fiber inspection probe tip assembly. The distal end of prism holder 22 is received and secured on stub 16c. Still referring to FIG. 3, assembly of straight tip long body fiber inspection probe 40 occurs in direction of arrow “A”. A proximal end of inner housing 20 is inserted into a distal end of fiber inspection probe tip assembly 16. Extended body 18, having latch assembly 19, is inserted over inner housing 20 and secured within fiber inspection probe tip 16. Latch assembly 19 helps secure and orient the measurement device secured to a distal end of extended body 18 by threaded end with taper 14. The measurement device provides light source, “LS” as depicted in FIG. 2. The measurement device is a typically a split light beam device with an image sensor and display to provide a visual of distortions at a ferrule endface as depicted in FIG. 10. As described below, prior art probe 10 provides a false measure of distortions at the ferrule endface due to probe tip 12 is offset to account for APC cut of the ferrule endface. Prior art probe 10 deploys a mechanical offset to inspect LC APC connector endfaces. A typical measurement device is a Senko® SmartProbe sold by the assignee of the present invention. The two industry endface types are described in FIG. 16.

FIG. 4 depicts fiber inspection probe tip assembly 16 and the proximal end of inner housing 20. Prism holder 22 has at least one rotational adjustment cut-out at a distal end of holder 22. Rotational adjustment cut-out 22a accepts a tool to rotate wedged prism 24 into focus before assembling the fiber inspection probe tip assembly 16. This focus step is needed to ensure captured image does not generate false distortions when angle cut 24a at wedged prism is not parallel with the APC ferrule endface of the fiber optic connector being imaged.

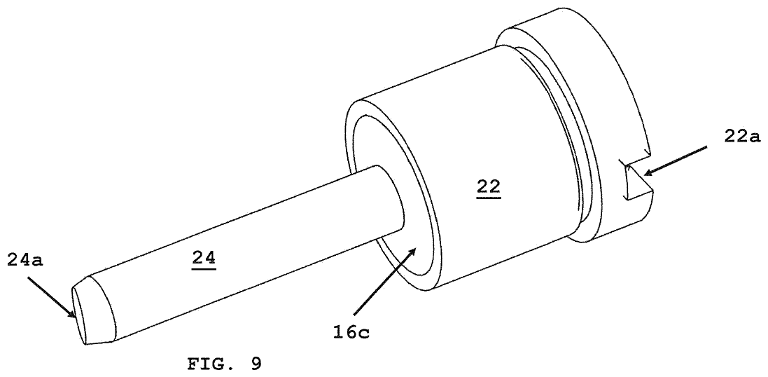

FIG. 5 depicts plug frame housing 16a and body portion 16e of fiber inspection probe tip 16. Prism holder 22 is secured with plug frame 16a by stub 16c being accepted into opening 22b (refer to FIG. 8) at a distal end of prism holder 22, along assembly line “A” (refer to FIG. 3 and FIG. 4). Injector port 16d on opposing sides is formed as part of plug frame housing 16a, which allows for the injection of flexible sealant or adhesive 26 to secure wedged prism 24 within prism holder 22. After sealant 26 is cured or sets, wedged prism 24 is focused to reduce image distortions (refer to FIG. 10) too no less than 4% but no greater the 6%.

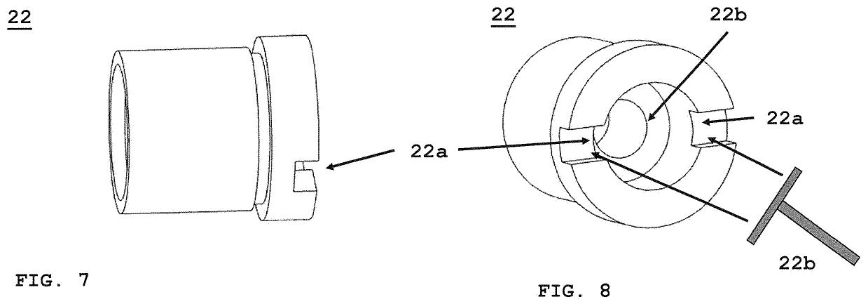

FIG. 6A depicts endface of wedged prism 24 as an APC face, at A-A of FIG. 6B, with flexible sealant 26 substantially about the wedged prism as depicted in FIG. 6A and FIG. 6B. FIG. 6B depicts wedged prism 24 secured within prism holder 22 by sealant 26 along longitudinal axis of probe L-L′. FIG. 7 depicts prism holder 22 with at least one rotational adjustment cut-out 22a. FIG. 8 depicts the distal end of FIG. 7 depicting two rotational adjustment cut-out 22a. Opening or recess 22b receives stud 16c. As described above and summarized here, wedged prism 24 is focused by inserting tool 22c into rotational adjustment cut-outs 22a and turning clockwise or counter clockwise to set wedged prism 24 focus to about 4% distortion. FIG. 9 depicts prism holder 22 with wedged prism 24 inserted onto stud 16c at a proximal end of the stud. Proximal end of wedged prism 24 depicts APC endface offset cut 24a.

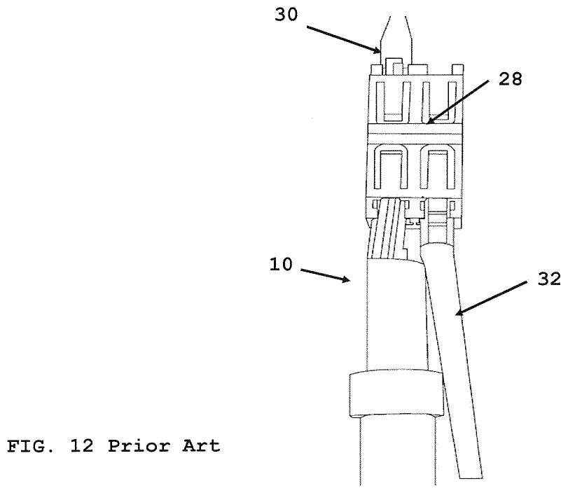

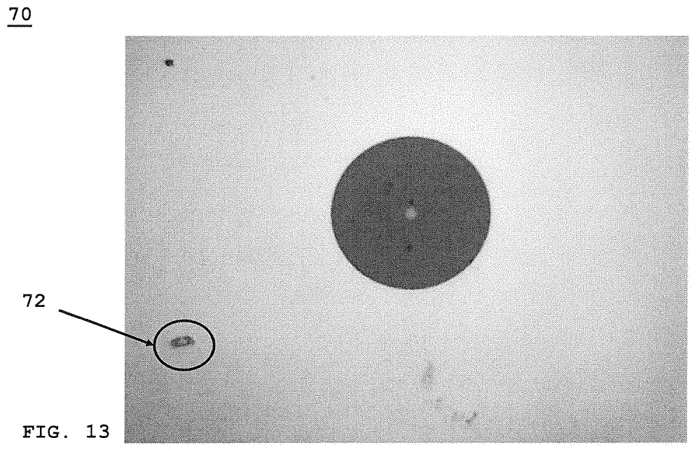

FIG. 10 depicts an image using prior art probe 10. The FIG. 10 image results from inspection probe 10 bent tip 12 as depicted in FIG. 11 or FIG. 12. Probe tip 10 results in poor image quality in terms of brightness, contrast and sharpness as compared with FIG. 13 due to a large number of distortions 62, which are shown as stray dark marks. FIG. 10 has a dark border which is absent in the present invention probe 40. This dark border is caused by the edge of the adapter (not shown) and is not avoidable using probe 10 because of the mechanical offset of the probe tip 12.

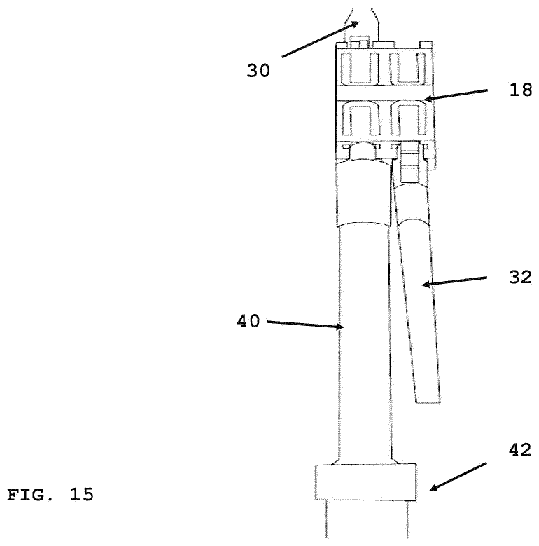

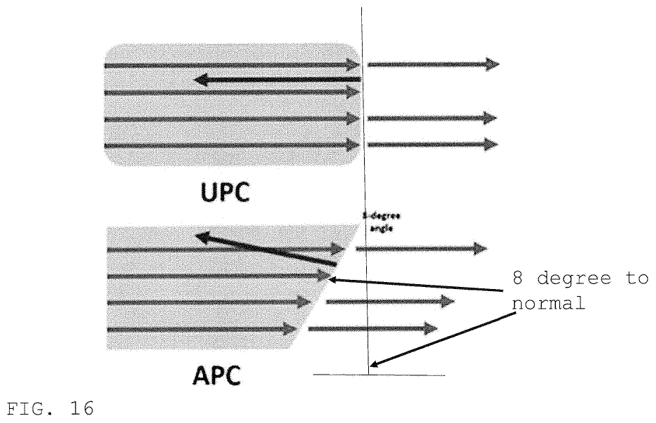

Comparing FIG. 10 image and FIG. 13 image, distortions 72 are reduced substantially over prior art inspection device 10. The present invention probe 40 is an attachment for any measurement device, as threaded end with taper 14 is a standard in the industry. By deploying wedged prism 24 at about an eight degree angled cut (APC) at a light exiting end of wedged prism 24, then tip 16 can reach APC fiber endfaces in high density panels with adjacent fiber optic connectors as depicted in FIG. 14 and FIG. 15. Wedged prism 24 replaces an eight (8) degree mechanical offset deployed in prior art probe tip 12. Since the eight degree offset is required to properly inspect an APC endface, wedged prism 24 guides the inspection light from the measurement device, thus, removing the need for an eight degree mechanical offset in the present invention. To help achieve this high density measure extended body should be at least 50 mm but no more than 75 mm in length and substantially straight. Unlike prior art probe 10, probe 40 is straight along its longitudinal axis whereas by contrast probe 10 is offset at tip 12. So when the straight tip long body fiber inspection probe tip 40 is inserted into a port of an adapter, tip 40 does not interfere with adjacent fiber optic connector (30, 32), as depicted in FIG. 14 and FIG. 15.

Referring to FIGS. 11 and 12, offset probe tip 12 shows tip 12 interfering with adjacent fiber optic connector 30 in FIG. 11 and connector 32 in FIG. 12. This increases false measures of distortions and dark borders. Dark borders interfere with image quality. Furthermore, due to a mechanical design in probe tip 12 of prior art inspection tip 10, short body 13 interferes with the strain relief boots of fiber optic connectors (30, 32) as shown in FIGS. 11 and 12, particularly in high density situations. This results in probe tip 12 not being fully inserted into adapter. Without full insertion, the measurement device cannot measure as the light signal is dispersed and lost. With a longer boot fiber optic connector as depicted in FIG. 12, threaded end on the distal end of the inspection probe interferes with longer boot which worsens inspection. Because of the eight (8) degree offset tip 12 there is no mechanical way to construct short body 13. With wedged prism 24, a longer body or extended body 18 can be constructed.

Referring to FIG. 6A and FIG. 6b, wedged prism 24 is located at the front end of fiber inspection probe tip assembly 16. The wedged prism acts as an optical beam steering device. Incident light (from the measurement device) enters the wedged prism face that is perpendicular to the optical axis or opposite angled cut 24a. The incident light from the measurement device enters the prism at 0 degrees and per Snell's Law there is no refraction that takes place at this interface, however when the light reaches the angled end of the prism it is refracted downwards or bent at an angle dictated by the angle of the prisms front face, or about eight (8) degrees, and the refractive index of the prism's glass type. The prisms front angle has been calculated to allow the refracted light beam to strike the ferrule's endface perpendicular to its 8° face, which means a zero (0) degree entry point and no refraction loss per Snell's Law into ferrule endface. The transmitted light is then reflected back through the prism and imaged onto the probes image sensor. It should be noted that the front face of the prism, when the tip is fully inserted into the LC Adapter, is less than 0.50 mm from the face of the ferrule. This is one of the important design features of this tip as closeness of the two faces minimizes image offset and image distortion. The low distortion achieved enables image analysis software to more easily to compensate for it. It should be noted, the return light or reflected light off the ferrule endface is imaged by the measurement device. And since this ferrule endface light contains information on the distortions present on the ferrule endface, a zero angle entry point maximizes signal transmission or reduces loss under Snell's Law.

The LC Adapter contains a split sleeve, used to mechanically align and mate two LC ferrules together. In adapter inspection is carried out with only one ferrule in position. The inspection tip is inserted into the vacated side of the adapter to inspect the in situ ferrule's end face. To achieve a 0.5 mm distance between ferrule endface and micro prism, the prism must enter the split sleeve. The glass micro prism has a smaller outer diameter than the internal diameter of the split sleeve, making it vulnerable to breakage when entering/leaving the split sleeve. To avoid breakage the prism is held in position within the prism holder with a Silicone encapsulating adhesive. Adhesive 26, when cured, is a very flexible, high tear strength encapsulant, which allows wedged prism 24 to move without damage and subsequently return to exactly to its original rest position. An added advantage of this flexible mounting technique is that it allows a small degree of self-alignment. This ‘self-alignment’ helps keep the end face image under inspection better centralized in the display. The self-alignment is done using tool 22c as described above. This flexible prism mounting design is a novel and important feature in the inspection of APC ferrules where offsetting the tip/probe by 8° is not possible with prior art inspection probe 10.

FIG. 16 depicts an APC cut endface for a ferrule and an UPC cut endface for a ferrule. UPC endface ferrules have a low insertion loss but a high reflection of light back into the light source, called return loss. This interferes with the light signal or information. An APC cut reflects light back toward the outer layer or cladding or a low return, loss. Industry standard is about an eight (8) degree cut to the normal of the endface for APC. The objective is to have a low return loss, which is a trade-off as an UPC endface has a lower insertion loss than APC endface. APC endface technology has improved decreasing insertion loss, so the present invention is important to ensure the APC endface is not distorted. It is the distortion that increases insertion loss. Loss is measure in decibels or dB.

In the present invention, the APC angle is optically offset by wedged prism 24 to allow inspection of LC APC connector ferrule endface shown in FIG. 16. Wedged prism 26 allows for extended body 18 to help avoid contact with adjacent fiber optic connector 32 as described below, in FIG. 14, and allow for long, straight tip design. An offset prior art tip 12 is depicted in FIG. 1.

The embodiments were chosen and described in, order to best explain the principles of the invention and its practical application, thereby enabling others skilled in the art to understand the invention for various embodiments and with various modifications that are suited to the particular use contemplated.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which, are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”) the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and. C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera).

1. A fiber inspection probe tip assembly, comprising:
a wedged prism having a first end with a perpendicular cut and second end with an offset cut relative to a longitudinal axis of light entering at the perpendicular end; and
a prism holder with a first end to secure the wedged prism at a proximal end of the prism holder and a second end of prism holder configured to accept a plug frame assembly for insertion into an adapter port.

2. The fiber inspection probe tip assembly according to claim 1, wherein
the prism holder has an opening configured to accept a stub formed as part of the plug frame assembly for accepting a distal end of prism holder.

3. The fiber inspection probe tip assembly according to claim 1, wherein
prism and prism holder are substantially in-line with an extended long body when assembled along the longitudinal axis of the fiber inspection tip assembly.

4. The fiber inspection probe tip assembly according to claim 1, wherein the plug frame assembly further comprises an alignment key positioned on a side of the plug frame housing for ensuring the assembly is properly inserted into an adapter port.

5. The fiber inspection probe tip assembly according to claim 4, wherein the plug frame housing has at least one injection port for receiving the flexible adhesive, and further wherein the flexible adhesive secures the wedged prism within the prism holder.

6. The fiber inspection probe top assembly according to claim 1, wherein the flexible adhesive substantially surrounds a distal end of the wedged prism for securing the wedged shape prism within the prism holder.

7. The fiber inspection probe tip assembly according to claim 7, wherein the prism holder has at least one rotational adjustment cut-out for allowing the wedged prism to be rotated and focused to reduced image distortion.

8. The fiber inspection probe tip assembly according to claim 1, wherein the offset cut is along the ferrule endface at an angle between six degrees to the normal formed along the longitudinal axis of the fiber inspection probe tip assembly and the offset cut is at the ferrule endface at an angle less than ten degrees to the normal formed along the longitudinal axis of the fiber inspection probe tip assembly.

9. The fiber inspection probe tip assembly according to claim 1, wherein the offset cut is along the ferrule endface at an angle of about eight degrees to the normal formed along the longitudinal axis of the fiber inspection probe tip assembly.

10. A fiber inspection probe, comprising:
an extended body;
a fiber inspection probe tip further comprising a wedged prism at a first end of the fiber inspection probe tip;
the extended body accepts the fiber inspection probe tip at a first end and a measurement device that delivers light at a second end into the extended body; and wherein
the light enters the wedged prism at zero degrees and is bent at approximately eight degrees through the wedged prism and exits the wedged prism and enters the ferrule endface at zero degrees for reducing refraction loss thereby improving inspection quality for distortions of an optical fiber embedded in the ferrule endface and the ferrule endface.

11. The fiber inspection probe according to claim 10, wherein a first end of the prism is cut at an angle of about eight (8) degrees at a light exiting endface of the prism.
